(19) United States
(12) Patent Application Publication
(10) Pub. No.: US 2015/0098631 A1
(43) Pub. Date: Apr. 9, 2015

(54) APPARATUS AND METHOD FOR RECORDING EVIDENCE OF A PERSON'S SITUATION

(71) Applicant: A.V.A., LLC, FORT WORTH, TX (US)

(72) Inventors: John Vernon Palmer, Fort Worth, TX (US); Edward Michael Gregory, Sumner, TX (US)

(73) Assignee: A.V.A., LLC, FORT WORTH, TX (US)

(21) Appl. No.: 14/045,583

(22) Filed: Oct. 3, 2013

(51) Int. Cl. H04M 1/02; G06K 9/00

(52) U.S. Cl. CPC H04M 1/0264; G06K 9/00288; G06K 9/00087
USPC 382/118; 455/556.1; 382/124

(57) ABSTRACT

An apparatus and a method are provided for detecting and recording, in an electronic device, evidence of a person's situation. Situation data is detected using a situation data sensor in the electronic device. Situation data can be data representing evidence of a person's situation, wherein such evidence can show a person's place in relation to another person or thing, or the state of a person being able to interact with another person or thing. Next, biometric data of the user of the electronic device is detected. Biometric data can be data that represents one or more intrinsic physical or behavioral traits of a person. Thereafter, a report is created using the situation data and the biometric data, wherein the report includes evidence of the situation of the user of the electronic device.

### TECHNICAL FIELD

The disclosed embodiments relate generally to electronic devices, and more particularly to portable electronic devices capable of collecting, storing, and reporting evidence that a person has been in a particular situation.

### BACKGROUND OF THE INVENTION

On many occasions, it can be desirable to collect evidence that a particular person is, or has been, in a particular situation. A person's situation can be defined as a person's place in relation to another person or thing, or the state of a person being able to interact with another person or thing. A person's situation can include, for example, a situation where the person is in a meeting with another person, such as meeting with a counselor or client. Thus, the person can be situated in a place to have an interaction (e.g., conversation, visual communication, and the like) with another in the meeting.

In another example, a person's situation can include the person being in the presence of, or near, a particular thing, such as a valuable item or cargo, wherein the person is close enough to interact with, observe, or otherwise perceive, protect, or inspect the thing. This can be, for example, the situation of a bodyguard protecting a person, or a security guard protecting a thing.

Recording evidence of a person's situation can be useful for proving the person has met an obligation with respect to being in a particular situation. For example, evidence of a person's situation can be used to monitor a person's attendance at a particular event or meeting. As a more specific example, a parole officer can use such situational evidence to ensure that a parolee attends events like community service or counseling sessions.

In some situations it can be beneficial to collect evidence of a person's situation while maintaining the anonymity of the person (or other persons in the situation). For example, as part of the conditions of parole, a parole officer may want to confirm that the person (i.e., a parolee) has attended a required meeting without revealing the identity of the person, or any other person, attending the meeting. For example, a person attending a self-help group (e.g., alcoholics anonymous) may be required to anonymously attend meetings, which means that a sign-in sheet, a roll call, or other traditional verification means cannot be used as evidence of a persons attendance (i.e., evidence of the person being in the situation of the meeting) because these methods may not maintain the anonymity of the group's members.

Employers may also benefit from collecting evidence of a person's situation. An employer may have an employee that is responsible for attending events or meetings as a condition of employment. Thus, it may be desirable to have a system for collecting evidence that the employee has attended a required event or meeting rather than merely taking the employee's word for it.

Many cellular telephones and other wireless devices include a global positioning system (GPS) receiver capable of precisely determining the location of the device, and perhaps the user of the device. GPS receivers have made it easier to collect evidence that an electronic device is in a particular geographic location. But knowing the geographic location of the electronic device may not be sufficient evidence that a particular person was in a particular situation. For example, the person (e.g., the smart phone's owner or user) can merely arrange for the smart phone (i.e., the electronic device), to be with another person at the event while the user is somewhere else, thus faking evidence that the person is in a particular situation. And sometimes the GPS receiver cannot receive a sufficient signal from the GPS satellite transmissions so that a location cannot be determined. This frequently occurs when the GPS receiver is inside a building or in a place where GPS signals are obstructed or attenuated. Thus, relying upon GPS location finding may frustrate the ability to monitor a person's situation in locations with GPS signal attenuation or interference.

Even if the person truly has the phone, and sufficient GPS signals are received, recording the geographic location may not be sufficient to indicate that the person was in a particular situation. For example, if a person is required to attend a counseling session, and the meeting is moved from its scheduled location to a temporary location, evidence that the person is at the scheduled geographic location is not the best evidence that the person was in the actual meeting, which occurred in the temporary location. Thus, if the person attends the counseling session as required, recording the temporary location may appear as if the person was not attending the required meeting because it is not the scheduled location. Conversely, if the scheduled location is recorded, it may appear that the person attended the counseling session, but in reality they did not because it occurred in the temporary location.

In other cases, the situation the person is supposed to be in changes location, where the location may be either known or unknown. For example, it may be desirable to record evidence that a person, such as a body guard, security guard, or prison guard, has been in a situation that allows him or her to diligently monitor the wellbeing of a person or thing, regardless of the geographic location of the person or thing. If the person or thing moves in an unknown route to an unknown location, recording evidence that the guard was in a particular geographic location may not be sufficient evidence that the guard was in a situation where he or she could monitor, interact with, or otherwise determine or ensure the wellbeing of the guarded person or thing.

In view of these deficiencies in the ability to collect reliable and more conclusive evidence of a person's situation, an improved apparatus and method for collecting evidence of a person's situation is needed. It is in view of this background information related to the design and use of an electronic device that the significant improvements of the present disclosure have evolved.

### BRIEF DESCRIPTION OF THE DRAWINGS

For a better understanding of the embodiments disclosed herein, as well as additional embodiments thereof, reference should be made to the Detailed Description below, in conjunction with the following drawings in which like reference numerals refer to corresponding parts throughout the figures.

FIG. 1 illustrates an electronic device in accordance with an embodiment of the disclosure;

FIG. 2 is a schematic representation of an embodiment of a communication system that includes the electronic device shown in FIG. 1;

FIG. 3 depicts a high-level functional block diagram of an electronic assembly for operation of the electronic device 20 shown in FIG. 1;

FIG. 4 is a high-level flowchart illustrating a method of recording evidence of a person's situation in accordance with an example embodiment of the present disclosure;

FIG. 5 illustrates people in a meeting situation with a barcode posted;

FIG. 6 depicts the use of electronic device 20 shown in FIG. 1 having front and backward facing cameras to detecting situation and biometric data in accordance with an example embodiment of the present disclosure; and

FIG. 7 illustrates an example of a user interface with instructions and menus for controlling the operation of electronic device 20 in accordance with an example embodiment of the present disclosure.

### DETAILED DESCRIPTION

An embodiment of the present disclosure advantageously provides an apparatus and a method for recording evidence of a person's situation. The disclosure generally relates to an electronic device, such as a cellular phone, smart phone, computer tablet, portable computer, and other similar electronic data processing devices that are capable of sensing and recording data related to a person's situation.

For simplicity and clarity of illustration, reference numerals may be repeated among the figures to indicate corresponding or analogous elements. Numerous details are set forth to provide an understanding of the embodiments described herein. Some embodiments may be practiced without these details. In other instances, well-known methods, procedures, and components have not been described in detail to avoid obscuring the embodiments described. The description should not be considered as limited to the scope of the embodiments described herein.

Evidence of a person's situation can include evidence that a person is near, or in the presence of, another person or another thing, so that the person can observe or interact with the other person or thing. Such interaction can include conversation with another person, observation of another person or thing, being in a meeting with a group of persons, and the like. If a person is observing a thing, the interaction with the thing can include inspection to determine the status or wellbeing of the thing.

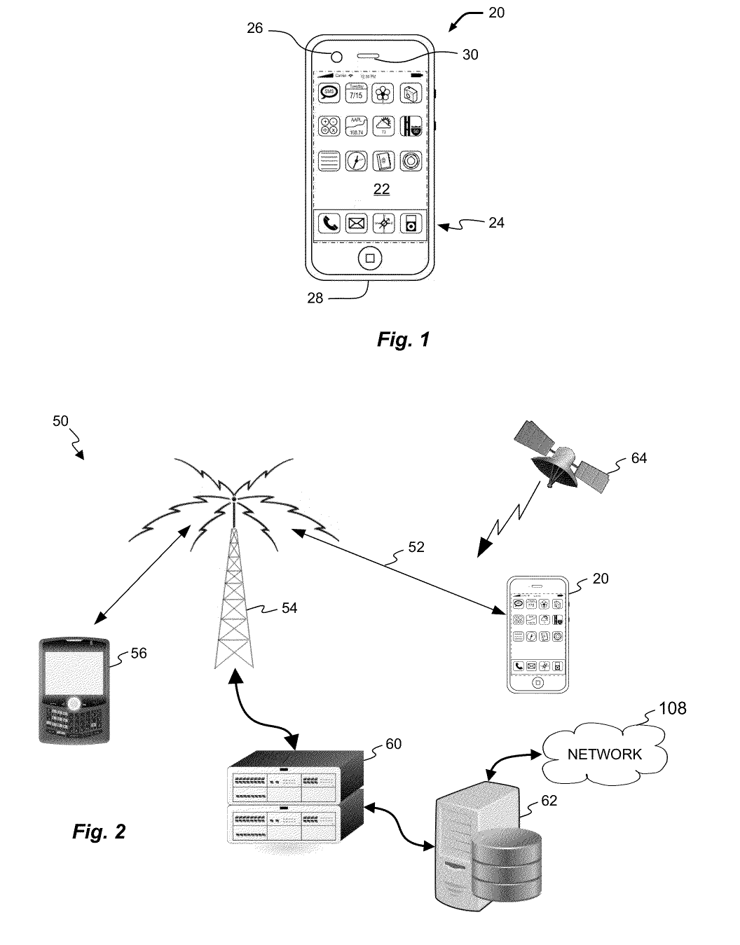

Referring first to FIG. 1, a representative electronic device 20, is depicted. In FIG. 1, electronic device 20 is illustrated as a smart phone. In other embodiments of the disclosure, electronic device 20 can include cellular telephones, tablet computers, laptop computers, netbooks, and other data processing devices capable of sensing and recording data that is evidence of a person's situation. Electronic device 20 may also be able to communicate data, either wirelessly or by physically connected media, in formats including text data, image data, video data, data files, command and control information, and similar data types.

Electronic device 20 can include display 22, which can be used to display data, menus, photographic images, and other similar functions of electronic device 20. In some embodiments, display 22 can be a touchscreen, which can be sensitive to human touch or input with a stylus. Display 22 can display a user interface, including a keyboard or icons 24, which depict buttons that can be used to operate electronic device 20 by entering data, or selecting various menus and functions. In other embodiments, electronic device can include a physical keyboard or buttons. In some embodiments, the user interface can include speech recognition and speech interpretation of commands for operating electronic device 20.

Electronic device can include microphone 28, which can be used in capturing sound or audio data, which may include voice data, commands, or voice samples.

In some embodiments of the disclosure, electronic device 20 can include one or more cameras 26 for capturing image data or scanning barcode data. If more than one camera 26 is included, one may be on the front (e.g., display side) of the electronic device (shown at camera 26 in FIG. 1), and another camera may be on the back (which is not shown). Display 22 can be used to display data (image data, instructions, scanning targeting aids, or other similar data) associated with taking a photograph or scanning a barcode. Note that camera 26 in combination with screen functions and other software modules and functions can together function as, and be referred to as, a barcode module.

Referring now to FIG. 2, there is depicted communication system 50, which can include electronic devices, such as electronic device 20. In various embodiments of the disclosure, electronic device 20 can have a wireless communication link 52 with base station 54. Base station 54 can be coupled to switch 60 to provide a connection with another network, such as a telephone network, data network, or Internet network, which network can be connected to server 62. Base station 54 can be a cellular radio tower, a local area network (LAN) access point, or other similar wireless communication network device. Communication link 52 can be implemented with any one of several known communication technologies or standards.

Electronic device 20 may be capable of operating in a communication session, such as a telephone call or a data communication session, with other devices in communication system 50. For example, electronic device 20 may be able to implement a voice or data communication session with wireless device 56, which device can be similar to electronic device 20. Additionally, electronic device 20 can be in a data communication session with server 62, and network 108, via switch 60.

In various embodiments, switch 60 can be capable of switching (e.g., connecting) voice communication sessions or data communication sessions, wherein telephone conversations are supported by voice communication sessions (i.e., a voice call), and file transfers, web browsing, multimedia data sessions, or the like can be supported by data communication sessions (i.e., a data call). In some embodiments, switch 60 can have functions and signaling capabilities that support the apparatus and method disclosed herein.

In various embodiments of the methods and apparatus disclosed herein, functions may be implemented in a single device on one end of a communications session, or functions may be distributed between two networked electronic devices. Also, some functions used to implement the apparatus and methods disclosed herein can be implemented in a server connected to (or within) switch 60, or a server connected via the Internet or network 108.

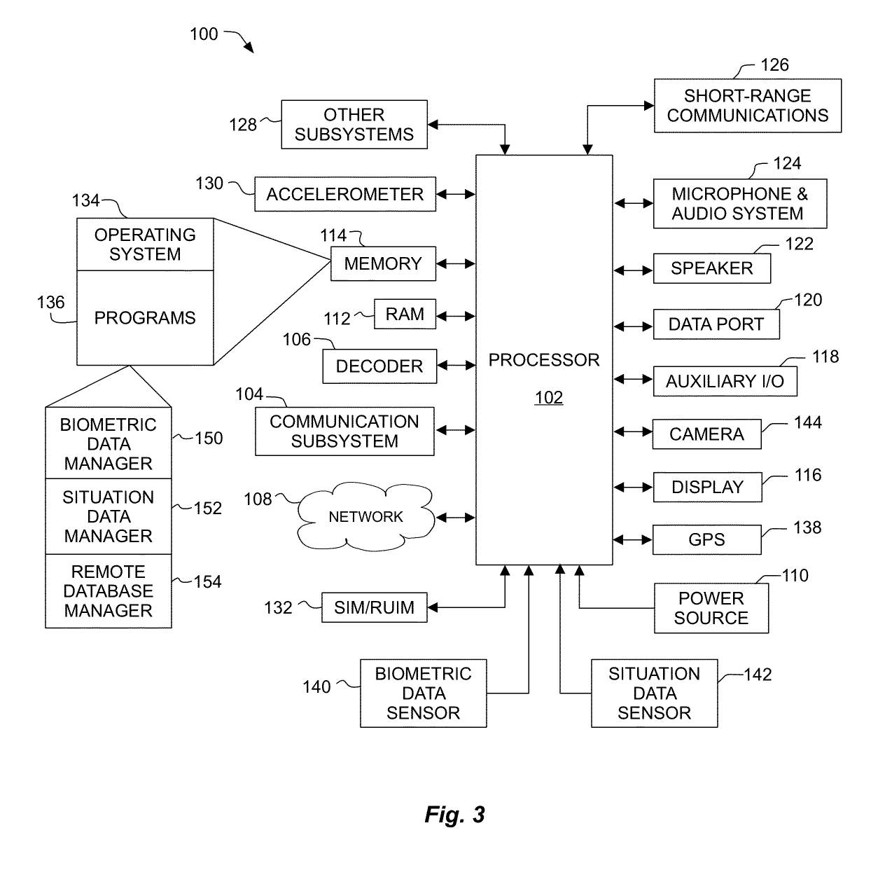

With reference now to FIG. 3, there is depicted a high-level functional block diagram of an electronic assembly 100 for operating an electronic device, such as electronic device 20 shown in FIG. 1. Electronic assembly 100 can include multiple components, such as processor 102, which can control the overall operation of electronic device 20 using various combinations of hardware, software, and firmware.

In some embodiments, processor 102 can be implemented with a so-called “system-on-a-chip” device capable of supporting an ARM processor core (which is developed by ARM Holdings plc., a Cambridge, England multinational semiconductor and software design company), or the like.

Communication functions provided by electronic device 20 can include voice, data, and command communications, which may be provided by communication subsystem 104. Communication subsystem 104 can be used to initiate and support an active voice call or data session. Communication subsystem 104 can include various combinations of hardware, software, and firmware to perform a designed function. The software can be functionally or conceptually divided into software modules. And software in one module may share, or call upon, functions in other modules.

Data received by electronic device 20 can be processed (e.g., decompressed or decrypted) by decoder 106. Communication subsystem 104 can receive messages from, and send messages to, network 108, which can be a wired or wireless network. Network 108 may be any type of wired or wireless network, including, but not limited to, a cellular network, a wireless data network, a wireless voice network, and a network that supports both voice and data communications. If network 108 is a wireless network, it can use a variety of formats, such as those specified by standards including Global System for Mobile Communications (GSM), Code division multiples access (CDMA), Wi-Fi wireless Ethernet (Institute of Electrical and Electronics Engineers standard 802.11), LTE (Long Term Evolution standard by the 3^{rd} Generation Partnership Project (3GPP)), and other similar standards and wireless networks.

Power source 110 can provide power to operate electronic device 20, and can be implemented with one or more rechargeable batteries, or a port to an external power supply, wherein such power supply provides the appropriate power to components of electronic assembly 100.

Processor 102 can interact with other components, such as random access memory (RAM) 112, memory 114, display 116 (illustrated in FIG. 1 as display 24), auxiliary input/output (I/O) subsystem 118, data port 120, speaker 122, microphone and audio system 124, short-range communications subsystem 126, and other subsystems 128. RAM 112 and memory 114 can each be referred to as data memory. A user can enter data and operate functions of electronic device 20 with a data input device coupled to processor 102. Data input devices can include buttons or keyboard 22 (see FIG. 1), or, in some embodiments, a graphical user interface produced on display 116, which can use touches and gestures detected using a touch-sensitive function as part of display 116. Processor 102 can interact with keyboard 22 and/or the touch-sensitive function via an electronic controller (which can be represented by other subsystems 128). As part of the user interface, information, such as text, characters, symbols, images, icons, and other items that may be displayed or rendered on electronic device 20, can be displayed using display 116. Processor 102 can also interact with accelerometer 130, which may be used to detect a direction of a gravitational force, or user-input acceleration forces. Detecting a gravitational force can be used to determine the attitude or orientation of electronic device 20 at a particular time.

To identify and authenticate a subscriber for obtaining access to network 108, electronic device 20 can use a subscriber identity module or a removable user identity module (SIM/RUIM) card 132. Alternatively, user identification information can be programmed into memory 114.

GPS module 138 can be used to receive radio signals that can be used to provide location and time information for use within electronic device 20.

Electronic device 20 can include operating system 134 and software programs 136, which can both be executed by processor 102. Examples of operating system (OS) 134 can include: Google's Android, Apple's iOS, Nokia's Symbian, Blackberry's BlackBerry OS, Samsung's Bada, Microsoft's Windows Phone, Hewlett-Packard's webOS, and embedded Linux distributions such as Maemo and MeeGo. Operating system 134 and software programs 136 can be stored in a persistent, updatable store, such as memory 114. Additional applications or programs can be loaded onto electronic device 20 through network 108, auxiliary I/O subsystem 118, data port 120, short-range communications subsystem 126, or any other subsystem 128 suitable for transferring program files and related data.

A received signal, such as a text message, an e-mail message, or web page download can be processed by communication subsystem 104 and input to processor 102. Processor 102 can processes the received signal for output to the display 116 and/or to the auxiliary I/O subsystem 118. An electronic device user may generate data items, for example e-mail messages or data packets, which may be transmitted over network 108 through communication subsystem 104. For voice communications, the overall operation of electronic device 20 can be similar. Speaker 122 can be used to output audible information converted from electrical signals, and microphone and audio system 124 can be used to convert audible information into electrical signals for processing. Speaker 122 can include an earpiece component (as shown in FIG. 1) for private listening, and a loudspeaker component (not explicitly shown) for listening when the phone is not held to the user's ear, or for allowing others nearby to listen.

In order to gather evidence of a person's situation, electronic device 20 can include software programs 136, which can include software modules, such as biometric data manager 150, situation data manager 152, and remote database manager 154. Each module can be responsible for a particular function within electronic device 20, and the software modules can interact with and use various hardware and software resources within electronic device 20 to execute its respective function.

Biometric data manager 150 is a software module that can be used to gather (e.g., detect) and manage biometric data associated with the user of electronic device 20. Such biometric data can be used in the process of biometric authentication. Biometric authentication (or biometrics) can be defined as the process of uniquely recognizing individuals based upon one or more intrinsic physical or behavioral traits.

Biometric identifiers are distinctive, measurable characteristics that can be used to identify individuals. Two categories of biometric identifiers can include physiological characteristics and behavioral characteristics. Physiological characteristics can be related to the shape of the body. Examples can include, but are not limited to, an individual's fingerprint, palm print, face geometry, hand geometry, DNA, iris shape and color, and odor/scent. Behavioral characteristics can be related to the behavior of a person. Examples can include, but not limited to, an individual's typing rhythm, gait, and voice.

More traditional means of identifying an individual include token-based identification systems, such as a driver's license or passport, and knowledge-based identification systems, such as a password or personal identification number. While the present disclosure can use token-based and knowledge-based identification systems, biometric identifiers can be more reliable since they are unique to individuals.

Situation data manager 152 can be used to gather (e.g., detect) and manage the user's situation data. Situation data can be data representing evidence of a person's situation, wherein such evidence can show a person's place in relation to another person or thing, or the state of a person being able to interact with another person or thing. Situation data can be gathered by many kinds of sensors, such as, for example, a camera for taking photographs or digital images, a barcode scanner (which may also use the camera) for reading various types of barcodes, a radio receiver for receiving radio frequency (RF) data, a location finding module for determining a location of electronic device 20, and the like. Thus, situation data manager 152 can include software modules for gathering, processing, formatting, and communicating situation data gathered in electronic device 20.

Remote database manager 154 can be used to manage the transfer of data from electronic device 20 to a location where the user's situation can be monitored, reported, or analyzed. For example, remote database manager 154 can format and send reports to a remote database, where the data can be viewed or analyzed for the use of another person who is monitoring a situation of the user of electronic device 20. Remote database manager 154 can also be used to handle confirmations, retransmissions, authentications, handshaking, and other similar administrative and security functions involved in communicating data representing evidence of the user's situation. Remote database manager 154 can also be used to provide the user of electronic device 20 with assurances and confirmations of successful transmission of data.

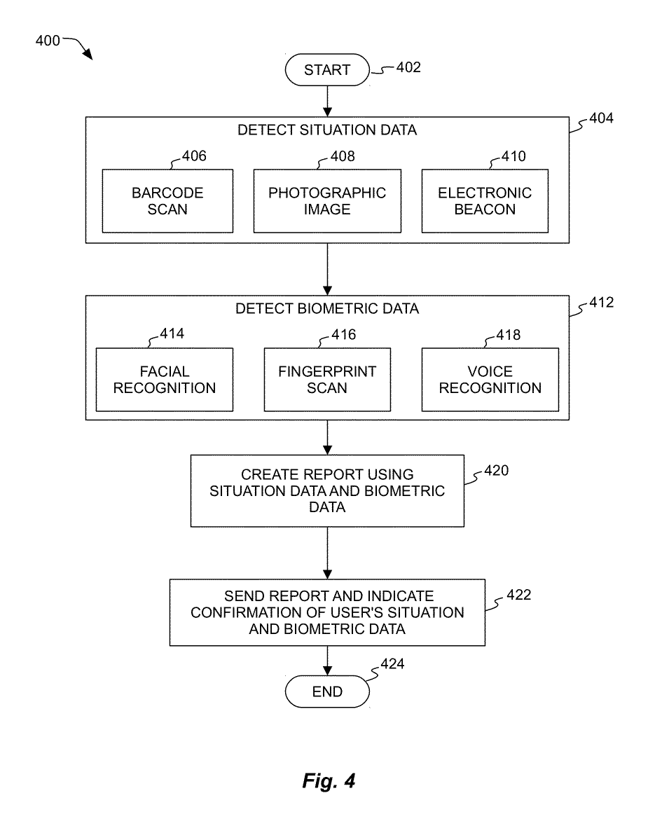

Referring now to FIG. 4, there is depicted a high-level flowchart illustrating an exemplary method of recording evidence of a person's situation in accordance with the present disclosure. In operation, the apparatus and method of the present disclosure can be controlled by software executed using hardware shown in FIG. 3. For example, the apparatus and method may be controlled by programs 136 executed by processor 102 within electronic assembly 100.

As illustrated, method 400 begins at block 402, and thereafter continues at block 404, wherein the method detects situation data. Situation data can be data that shows, or represents, or is evidence of, a person's (e.g., the user's) situation. A person's situation can be defined as a person's place in relation to another person or thing, or a person's ability to interact with another person or thing. Situation data can be detected using various software and hardware modules within electronic device 20, including situation data manager 152 and situation data sensor 142 shown in FIG. 3.

As an example, situation data can be data that is evidence of the person being in a place in relation to another person or thing, where the person can observe or interact with such other person or thing. Interacting with another person can include, among other things, meeting with the other person, conversing with the other person, listening to the other person, communicating with the other person, guarding the other person, and the like. Interacting with a thing can include, among other things, observing or inspecting the thing, operating the thing, evaluating or verifying the thing, assessing the wellbeing of the thing, perceiving the thing, and the like. In one example, the particular thing can be a valuable item or cargo that needs supervision or guarding, such as valuable gold or diamonds, hazardous or radioactive material, or the like.

Block 404 depicts several ways of detecting a user's situation data. In various embodiments of the disclosure, one or more of the ways shown in block 404 (and other similar ways) can be used to detect situation data.

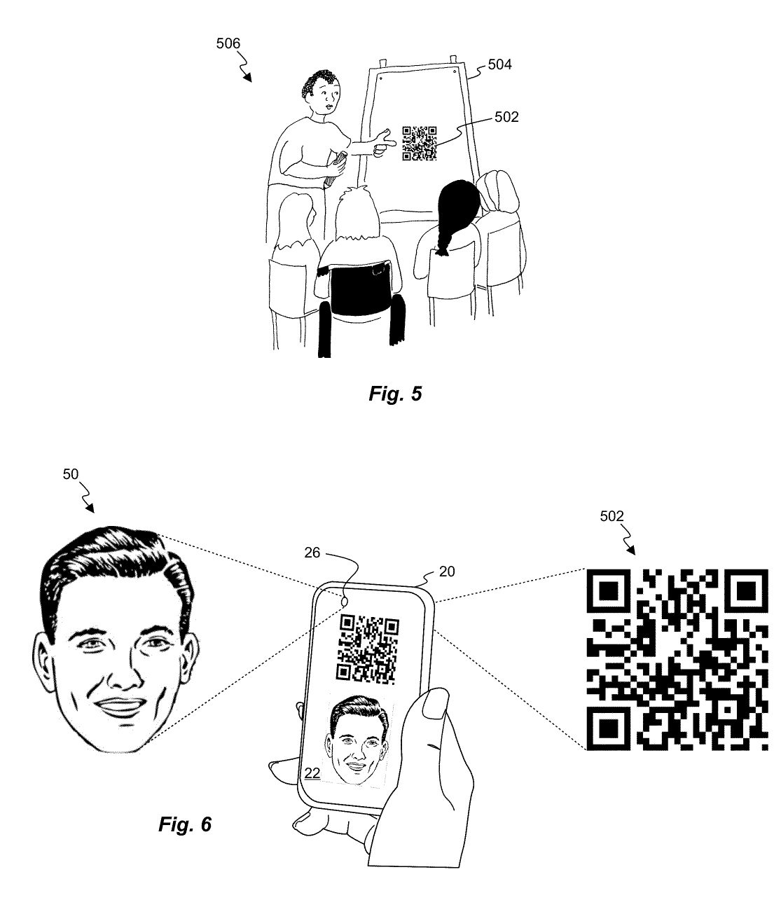

In one embodiment of the disclosure, detecting situation data can be implemented with a barcode scan, as illustrated at block 406. The barcode, which can be created uniquely for a particular situation (e.g., a meeting, a customer visit, or the like), can be posted in a location in the situation (e.g., in the meeting area) where it be scanned by people attending the situation (e.g., the meeting). As depicted in an example shown in FIG. 5, barcode 502 can be prominently displayed on presentation board 504 in meeting 506. When a user scans a barcode that has been created for a meeting it can be evidence that the user was in a particular situation. In the example shown in FIG. 5, scanning the meeting's barcode with electronic device 20 produces situation data that is evidence that the user was in the meeting, because the user operating electronic device 20 was close enough to barcode 502 to successfully scan the barcode, and therefore in the meeting area close to presentation board 504.

In addition to displaying a barcode in a meeting, a barcode can be secured to an object, such as a valuable package or cargo. Barcodes attached to things can be use to detect situation data that shows that the person was near the thing, where presumably the person's situation will allow the person to inspect, operate, or otherwise verify the status or wellbeing of the thing.

In the example of FIG. 5, barcode 502 can be implemented with a matrix (two-dimensional) barcode known by the trademark QR code. The QR code, which was developed by Denso Wave Incorporated in Japan, is a type of matrix barcode, which can be read faster and can store more data than traditional barcodes. QR codes can be printed on a standard piece of paper, or projected on a screen, in the room or place where the meeting is held. QR codes can also be displayed on, and scanned from, the screen of another smart phone that belongs to, say, the leader of the meeting. The QR code can be created and provided for the meeting (or other situation) from a central server connected to the Internet, which enables the creation of complex or secure data associated with the meeting. Such a complex code can be difficult to fake or fraudulently reproduce.

In some embodiments of the disclosure, camera 144 can be used as a situation data sensor to capture an image containing the barcode. Then, situation data manager 152 (and/or other subsystems 128) can be used to analyze the barcode data in the captured image.

The QR code can contain information associated with the meeting, such as a meeting identifier (e.g., an alphanumeric text string), and/or other information such as the meeting name, the meeting time, the meeting location, the meeting topic, meeting duration, and the like. In order to increase the veracity of the situation data, the information contained in the barcode is preferably secret, preselected data that is associated with the specific meeting, and that is unlikely to be guessed, predicted, or spoofed by the user.

As illustrated by block 408, detecting situation data can be implemented by capturing a photographic image. The photographic image may be captured using a front- or back-facing camera, such as camera 26 in electronic device 20. The photographic image can depict the user's situation, wherein the image can show that the user is near, or in the presence of, another person or another thing. The photographic image can, for example, show that the user is in a meeting with another person, such as a counselor or client. The composition of the photo of such other person can be evidence that the user is located close enough to take the photograph, and thus the user is close enough to interact with the other person in a meeting. The perspective and composition of a photograph of a particular thing can also show that the user's situation includes being in the presence of, or near, or proximate to, the particular thing, which, for example, may be a valuable item the user is supervising or guarding.

In some situations where the user is gathering situation data it may be important that the identities of persons remain confidential. If a photograph is used to detect situation data as shown in block 408, it may be difficult to maintain the anonymity of persons appearing in the photograph. Therefore, this method of detecting situation data may not be the preferred method when persons in the meeting need to remain anonymous. However, the method of block 406 that uses a barcode scan can allow people attending the meeting to remain anonymous.

Referring now to block 410, another method of detecting situation data can be implemented by receiving an electronic beacon. The electronic beacon can be a short-range signal that may require electronic device 20 to be in the area of the situation in order to receive the electronic beacon. For example, the electronic beacon can be implemented with a short-range Bluetooth signal (where Bluetooth is a wireless communication standard managed by the Bluetooth Special Interest Group). The beacon can transmit data that is uniquely associated with the situation, wherein, for example, the situation data can include a meeting identifier, a meeting name, a meeting security code, a meeting location and time, or other similar information. Electronic device 20 can use short-range communications module 126 to receive and decode information transmitted by the electronic beacon.

In alternative embodiments, detecting an electronic beacon can be implemented by reading data from a Radio-frequency identification (RFID) tag, or detecting data using a near field communication (NFC) technique. Reading data from an RFID tag involves the wireless, non-contact use of radio-frequency electromagnetic fields to transfer data that is electronically stored in the tag. Standards for RFID tags have been promulgated by various standards organizations, including, but not limited to, the International Organization for Standardization (ISO), the International Electrotechnical Commission (IEC), ASTM International (formerly known as the American Society for Testing and Materials (ASTM)), the DASH7 Alliance, and EPCglobal.

With regard to near field communication (NFC) the technology is described in a set of standards for radio communication between smartphones or similar devices for transferring data between each other by touching the devices together or bringing them into close proximity (usually no more than a few inches). NFC standards cover communications protocols and data exchange formats, some of which are based on existing radio-frequency identification (RFID) standards including ISO/IEC 14443 and FeliCa (i.e., Japanese Industrial Standard (JIS) X 6319-4). The standards include ISO/IEC 18092 and those defined by the NFC Forum.

Both RFID and NFC require that electronic device 20 be near the user's situation in order to detect or capture situation data. Thus, if the situation data is detected from an RFID or NFC enabled device, it is highly probable that the user of electronic device 20 was in the situation identified by, or associated with, the detected situation data. Situation data from RFID or NFC devices can be detected using software in situation data manager 152 and short-range communications subsystem 126. Note that communication subsystem 104, short-range communications module 126, and other subsystems 128 can, in whole or in part, be referred to as a signal-receiving module, or part of a signal-receiving module.

After situation data has been detected, process 400 passes to block 412 wherein biometric data is detected. Block 412 depicts several ways of detecting a user's biometric data. In various embodiments of the disclosure, one or more of the ways shown in block 412 (and other similar ways) can be used to detect biometric data. Biometric data is data that can represent one or more intrinsic physical or behavioral traits of a person, which can be used in a biometric process to uniquely recognize the user of electronic device 20. Detecting biometric data can be implemented by using biometric data manager 150 and biometric data sensor 140.

In one embodiment, detecting biometric data can be implemented with a facial recognition process using a photograph of the user's face (i.e., a captured facial image), as depicted at block 414. In different embodiments, facial recognition can be performed by a human, or by a computer using a facial recognition algorithm. If performed by a human, the user of electronic device 20 can take a photograph of their face (i.e., capture a facial image), and the photograph can be recognized by another person, such as another person who may be responsible for monitoring the user's situation (e.g., an employer, a supervisor, a parole officer, or the like). When a human performs the facial recognition, the recognition can be done at a later time in a remote location, perhaps by viewing the face photograph from a remote server connected via a network.

In a second more computerized implementation, recognition of the face photograph taken by the user can be implemented using a computer algorithm. A facial recognition program can be used to locate the user's face in the image, extract the face from the rest of the scene, and compare it to a database of stored images. The computer algorithm can analyze the digital image and compare, for example, the relative position, size, and/or shape of the eyes, nose, cheekbones, and jaw with a database of known characteristics of the user. The facial recognition function can be implemented with software, such as, for example, FACEIT® produced by IDENTIX®, a Minnesota, USA, company. Face images of the user or another person can be captured using either a front or back camera in electronic device 20 (see camera 26 in FIG. 1 and camera 144 in FIG. 3). Note that camera 26 together with facial recognition hardware and/or software can be referred to as a facial recognition module.

In another implementation, detecting biometric data at block 412 can be implemented using a fingerprint scan, as depicted at block 416. A fingerprint scanner or reader can be embodied in biometric data sensor 140, or externally coupled to electronic device 20, in order to collect fingerprint biometric data. The fingerprint sensor (an electronic device used to capture a digital image of the fingerprint pattern) can be used to capture a live scan. It can be implemented with one of several known fingerprint sensor technologies, including: optical, ultrasonic, passive capacitance, and active capacitance. Fingerprint recognition algorithms can include two major classes: “minutia” and “pattern.” A fingerprint scan can be digitally processed to create a biometric template (a collection of extracted features), which can be stored and used for comparison with a database of known biometric templates, which includes a previously detected biometric template of the user. Note that a fingerprint detector or scanner in combination with fingerprint recognition software and/or hardware may be referred to as a fingerprint recognition module. The fingerprint recognition module can perform the function of confirming a match between baseline fingerprint data and data captured from a fingerprint of the user.

In yet another embodiment, detecting biometric data at block 412 can be implemented by detecting a voice sample for processing by a voice recognition, or speaker recognition, algorithm, as illustrated at block 418. The act of identifying or authenticating a person using a voice sample can be referred to as speaker verification or speaker authentication. Speaker recognition can use the acoustic features of speech that have been found to differ between individuals. These acoustic patterns reflect both anatomy (e.g., size and shape of the throat and mouth) and learned behavioral patterns (e.g., voice pitch, speaking style). In various embodiments, voice recognition processing can be executed using biometric data sensor 140 and biometric data manager 150 in electronic device 20, or, alternatively, recognition of the voice sample can be executed in a remote server, such as server 62 shown in FIG. 2.

In some implementations of the disclosure, detecting situation data and biometric data can be executed simultaneously, or near simultaneously, by capturing images with the front and back cameras of a smart phone in response to a single input from the user, as shown in FIG. 6. This allows the user to capture highly probative evidence of a user being in a situation because, for example, a barcode uniquely displayed in a particular situation captured at the same moment with the user's face can provide convincing evidence that places the user in a particular situation. If data cannot be captured simultaneously, a time limit for capturing situation data and biometric data can be imposed. For example, once situation data is detected, a user may be required to capture biometric data within a 5 second time period. Failure to comply with the time period can be flagged for further investigation, or prevented from being recorded or reported.

Additional information can be detected and recorded along with situation and biometric data in order to increase the veracity of the evidence collected. For example, the attitude (e.g., orientation of electronic device's 20 axes with respect to gravity) of the phone can be recorded when scans or pictures are captured with electronic device 20. In one example, the attitude associated with both pictures should match if the user has simultaneously photographed their face in the front-facing camera and scanned the barcode with the back-facing camera. This type of data (i.e., metadata) recorded with the situation data and biometric data can increase the reliability of the data by increasing the difficulty of faking or falsely creating situation data and biometric data. Other data that can be recorded or encoded with the situation data and biometric data can include timestamp data, location data, and accelerometer data. Accelerometer data can be used to determine whether the user is stationary, walking, moving, or driving. Accelerometer data combined with other situation data can increase or decrease the veracity of the situation data, depending upon whether the accelerometer data (or other metadata) agrees with, or makes sense, in combination with the situation data.

After detecting both situation data and biometric data, process 400 can create a report using the situation data and the biometric data, as illustrated at block 420. This report can be a data set, or data packet, that is recorded in electronic device 20, which can use memory 114 or RAM 112. The data can also be prepared for transmission to another server or storage device for further analysis or archiving. In the server, the biometric data and the situation data can be further analyzed, by human or computer methods. In one embodiment, analysis at the server can determine whether or not a meeting was scheduled, the time the monitored person checked into the meeting, and provide an opportunity for the picture of the monitored person to be confirmed as the proper individual. Confirmation of the photograph can include comparing the photo taken by electronic device 20 with a photograph previously submitted when the individual was first registered with the server. This comparison can be implemented with a human comparing the two photographs on a computer screen, or it can be automated with facial recognition software that compares the pictures.

In one example, the report can be accessed on an Internet server by, for example, a parole officer to provide evidence that a parolee (i.e., electronic device 20 user) has attended required meetings or counseling sessions that are conditions of parole. In another example, an employer can access the report to verify that an employee is attending meetings, meeting with clients, guarding or providing security for a person or thing, or otherwise meeting obligations or conditions of employment. In yet another example, a parent can verify the situation of a child by reviewing evidence of location (e.g., the child being at home after school), or meeting another person responsible for care of the child (e.g., the child meeting an airline employee responsible for escorting the child after traveling by plane to another location).

Both situation data and biometric data can be compared to known baseline data, either in electronic device 20 or in a remote computer or server, such as server 62 in FIG. 2. The baseline situation data can be known data, which data can be used to create the barcode displayed in the meeting (e.g., data describing or identifying the meeting). The baseline situation data can be a known photographic image of a person or thing expected to be present in the documented situation (e.g., a photograph of the meeting room or person who leads the meeting), or a known data gram that can be transmitted by an electronic beacon (e.g., a beacon code transmitted uniquely at the meeting).

The baseline biometric data can be a known photograph of the user's face, a known fingerprint scan of the user's fingerprint, or a known voice sample of the user's voice. Baseline biometric data can be detected and stored in an initial registration process with the user of electronic device 20.

After creating the report, process 400 sends the report to a server, as depicted at block 422. Process 400 can also indicate confirmation from the server of receipt of the user's situation and biometric data. In some embodiments, a confirmation of a match with baseline data can be received and indicated on electronic device 20 so that the user knows a satisfactory report has been submitted and confirmed.

Thereafter, process 400 ends at block 424.

In order to draw accurate conclusions from evidence of a person's situation, it is useful to obtain two types of highly veracious evidence: (1) evidence of who the person is (e.g., biometric data) and (2) evidence of the situation (e.g., situation data). In many cases, evidence consisting of a GPS location of a known user's smart phone will not be reliable enough to conclude that the user was in a particular situation. Just because the user owns the phone, and the phone is at a particular location, does not mean the user was carrying the phone, nor does it mean the user was in a particular situation. Thus the method and apparatus of the present disclosure can be used to increase the veracity of evidence collected to show that a particular person was in a particular situation.

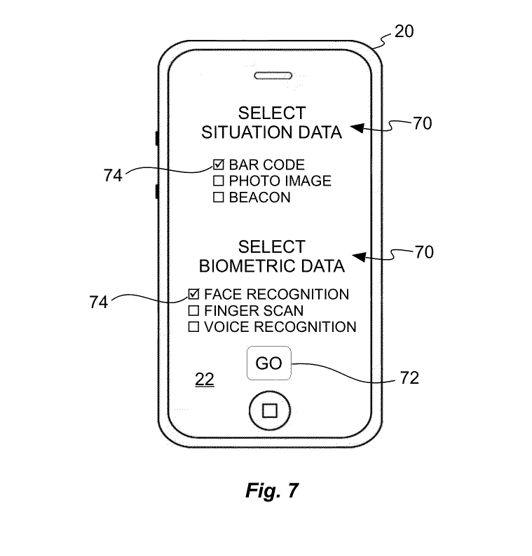

Using the method and apparatus of the disclosure, a user who needs to receive credit for attending a required meeting (or being in some other prescribed situation) can open an app on their smart phone or other electronic device 20 and log into the system using a personal ID and password. Once the app has initialized, the app can prompt the user to, for example, scan the barcode in the meeting room, where the barcode serves as one form of situation data, which is a form of evidence that the user was in a particular situation. Next, the user can be prompted by instructions on the smart phone display 22 to take a picture of their face with camera 26 in electronic device 20. The face picture can serve as one form of biometric data, which is evidence of the identity of the user. FIG. 7 illustrates an example of the use of instructions 70, menus, input buttons 72, and check boxes 74 on display 22 for operating electronic device 20.

If needed, further steps can be taken to increase the security and reliability of the disclosed method and apparatus to prevent users from “gaming” or deceiving the system. For example, after checking into the meeting, the user may be required to leave the smart phone on (e.g., in silent mode with vibrate on) with the app activated (e.g., running, perhaps in a background mode) during the meeting. Then, the user could periodically receive a text instructing the user to leave the meeting and go through another check-in using a separately located QR code (e.g., outside the room so as to limit disruption of the meeting). If the user was unable to check in again, it may be assumed that the user did not attend the whole meeting and therefore the user may not receive credit for attending that meeting. This lack of compliance could be documented for further scrutiny. This re-verification process is preferably required infrequently, and randomly, unless there are reasons to believe the system is being compromised. In other embodiments, the user could be required to scan out of the meeting when it is over, which can provide evidence that the user attended the entire duration of the meeting.

The evidence of the user's situation can be stored and used to create monthly reports of the user's attendance at the required meetings. The reports can include the original photographs of the user taken during their initial enrollment, and any photographs that could not be identified as a match with a high level of certainty. Other patterns or aberrations from the norm can be flagged in the data. Reports having biometric data and situation data that don't agree with any recorded metadata can also be flagged for further investigation. Any reports of the user's situation can be sent electronically through e-mail to a person responsible for monitoring the user's situation (e.g., judges, probation officers, attorneys, or the like).

In some embodiments of the disclosure, revenue can be generated from selling targeted advertising on a website space used to operate or manage the system. Advertising on the mobile interface of electronic device 20 may also be implemented. Persons or entities interested in marketing can purchase advertising targeted to a class of users, which can be defined by user-provided information, such as information that may be provided during registration with the system. For example, an airline may be interested in serving ads about airfares to a salesperson who is using the system to document meetings with clients. A police supply company may be interested in serving ads about tactical gear to security guards who are using the system to document the process of guarding an individual or valuable property.

Presently preferred embodiments of the disclosure, and many improvements and advantages thereof, have been described with particularity. The description includes preferred examples of implementing the disclosure, and these descriptions of preferred examples are not intended to limit the scope of the disclosure. The scope of the disclosure is defined by the following claims.

What is claimed is:

1. An electronic device comprising:
a processor;
a situation data sensor coupled to the processor for sensing situation data associated with a selected situation, wherein the situation data is evidence of a user's ability to interact with at least one of a person or a thing;
a biometric data sensor coupled to the processor for detecting biometric data of a user of the electronic device; and
data memory coupled to the processor for storing the data from the situation data sensor and the biometric data sensor.

2. The electronic device of claim 1 wherein the situation data sensor further comprises a barcode module for scanning a barcode, wherein the barcode is related to the selected situation.

3. The electronic device of claim 1 wherein the situation data sensor further comprises a signal-receiving module for receiving a transmitted signal, wherein the transmitted signal is related to the selected situation.

4. The electronic device of claim 1 wherein the situation data sensor further comprises a digital camera for capturing photographic data of the selected situation.

5. The electronic device of claim 1 wherein the biometric data sensor further comprises a camera for capturing an image of the user of the electronic device.

6. The electronic device of claim 5 wherein the camera is further coupled to a facial recognition module for performing facial recognition of a face of the user of the electronic device.

7. The electronic device of claim 1 wherein the biometric data sensor further comprises a fingerprint recognition module for performing fingerprint recognition of a fingerprint of the user of the electronic device.

8. A method in an electronic device for collecting evidence of a situation of a user of the electronic device, the method comprising:
detecting situation data using a situation data sensor in the electronic device, wherein the situation data is evidence of the user's ability to interact with at least one of a person or a thing;
detecting biometric data of the user of the electronic device; and
creating a report using the situation data and the biometric data,
wherein the report includes evidence of the situation of the user of the electronic device.

9. The method of claim 8 wherein the step of detecting situation data further comprises capturing a photograph of another person with a camera in the electronic device to collect evidence of meeting with the other person.

10. The method of claim 8 wherein the step of detecting situation data further comprises reading a barcode with a barcode reader in the electronic device to collect evidence of being in a situation associated with the barcode.

11. The method of claim 8 wherein the step of detecting situation data further comprises receiving a wireless signal with a signal receiver in the electronic device to collect evidence of being in a situation associated with the wireless signal.

12. The method of claim 8 wherein the step of detecting biometric data of the user of the electronic device further comprises capturing a facial image of the user.

13. The method of claim 8 wherein the step of detecting biometric data of the user of the electronic device further comprises performing a facial recognition of the user.

14. The method of claim 8 wherein the step of detecting biometric data of the user of the electronic device further comprises confirming a match between baseline fingerprint data and data captured from a fingerprint of the user.

15. A method in an electronic device for collecting evidence of a situation of a user of the electronic device, the method comprising:
capturing a first image related to the situation of the user;
capturing a second image related to the user of the electronic device; and
creating a record of the situation of the user including data related to the first and second photographs, wherein the record is evidence of the situation of the user.

16. The method of claim 15 wherein the first image related to the situation comprises an image of another person related to the situation.

17. The method of claim 16 further comprising the steps of:
performing facial recognition using the image of the other person to produce a first person identification;
performing facial recognition using the second image related to the user of the electronic device to produce a confirmed identification of the user; and
creating a record of the situation of the user including the first person identification and the confirmed identification of the user.

18. The method of claim 15 wherein the first image related to the situation comprises an image of a barcode associated with the situation.

19. The method of claim 18 wherein the image of a barcode associated with the situation further comprises an image of a barcode that contains information related to a particular meeting.

20. The method of claim 15 further comprising the steps of:
transmitting the record of the situation to a remote database; and
comparing the record of the situation to a predetermined situation record to produce a situation comparison result.
